(19) United States
(12) Patent Application Publication
(10) Pub. No.: US 2024/0202154 A1
(43) Pub. Date: Jun. 20, 2024

(54) MIRRORED SWITCH CONFIGURATION

(71) Applicant: CORNELIS NETWORKS, INC., WAYNE, PA (US)

(72) Inventor: GARY MUNTZ, LEXINGTON, MA (US)

(73) Assignee: CORNELIS NETWORKS, INC., WAYNE, PA (US)

(21) Appl. No.: 18/069,020

(22) Filed: Dec. 20, 2022

(51) Int. Cl. G06F 13/40; G06F 13/42

(52) U.S. Cl. CPC G06F 13/4022; G06F 13/4282; G06F 2213/0026

(57) ABSTRACT

A mirrored switch configuration is presented. The switch configuration includes at least two switches, each having corresponding baseline bandwidths and corresponding radix, and port configurations; a plurality of links, and a host fabric interface adapter (‘HFA’) including an interconnect adapted to receive, from corresponding ports of the at least two switches, one link from one port of one of the at least two switches and one link from a corresponding port of another of the at least two switches.

### BACKGROUND

High-Performance Computing (‘HPC’) refers to the practice of aggregating computing in a way that delivers much higher computing power than traditional computers and servers. HPC, sometimes called supercomputing, is a way of processing huge volumes of data at very high speeds using multiple computers and storage devices linked by a cohesive fabric. HPC makes it possible to explore and find answers to some of the world's biggest problems in science, engineering, business, and others.

Various high-performance computing systems support topologies with interconnects designed for high-speed data transmission and their manufacturers strive for higher and higher performance from various components. Bandwidth for data transmission in a fabric is a key component. Three factors that must be balanced when designing increased bandwidth capabilities of switches include the speed of a SerDes (Serializer/Deserializer), the cost of the SerDes, and the number of ports on the switch. Successive generations of network technology have increased the bandwidth of a link in a fabric, often doubling it in a given generation. Historically, this has been done by either increasing the count of electrical SerDes lanes in the link without changing the bandwidth of each link or retaining the electrical lane count while increasing the SerDes bandwidth. Both options typically require new components (ASICs) to fully benefit from the bandwidth increase.

Increasing the number of SerDes lanes in the link has the drawback of reducing the number of links supported by a device, or else increasing its size and cost. In a switch ASIC, for example, it may not be possible to increase the total SerDes lane count due to limitations in lithographic technology. Therefore, increasing the number of SerDes lanes per link generally forces a reduction in the radix or number of links a switch can support. Increasing the bandwidth of a SerDes lane has been very successful over time. But between the times when the industry successfully achieves such a transition, committing to higher SerDes bandwidth implies substantial technological risk and unpredictable schedule and cost implications.

Increasing the bandwidth of data transmission in a fabric is not straightforward, and as just mentioned, adoption of new components for higher bandwidth has its drawbacks. It would be advantageous to have an arrangement of the switches and links that increases the bandwidth of a fabric without these drawbacks.

### BRIEF DESCRIPTION OF THE DRAWINGS

Many aspects of the present disclosure can be better understood with reference to the following drawings. The components in the drawings are not necessarily to scale, with emphasis instead being placed upon illustrating the principles of the disclosure. Moreover, in the drawings, like reference numerals designate corresponding parts throughout the several views.

FIG. 1 sets forth a system diagram of an example high-performance computing environment with a fabric including mirrored switch configurations according to embodiments of the present invention.

FIG. 2 sets forth a line drawing of mirrored switches according to example embodiments of the present invention.

FIG. 3 sets forth a line drawing of a simplified example of a fabric having mirrored topologies of mirrored switch configurations according to example embodiments of the present invention.

FIG. 4 sets forth a block diagram of an example host fabric adapter according to embodiments of the present invention.

FIG. 5 sets forth a block diagram of a compute node configured for a fabric of mirrored switches according to embodiments of the present invention.

FIG. 6 sets forth a block diagram of an example switch.

FIG. 7 sets forth a flowchart illustrating an example method of configuring a fabric for a high-performance computing environment.

### DETAILED DESCRIPTION

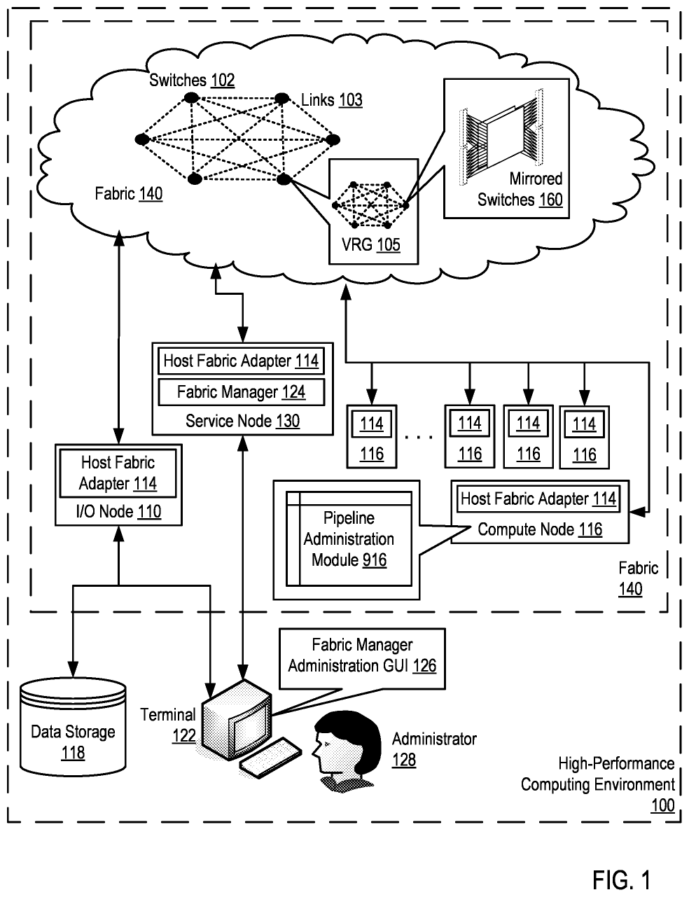

Methods, systems, devices, and products for high performance computing with mirrored switch configurations are described with reference to the attached drawings beginning with FIG. 1. FIG. 1 sets forth a system diagram of an example high-performance computing environment (100) with a fabric including mirrored switch configurations according to embodiments of the present invention. As will be shown in more detail below, mirroring the switches and their links and combining them in an adapter enables doubling the bandwidth of the fabric without drawbacks by providing parallel and independent topologies of mirrored switches. The exposed radix of the individual switches so mirrored is unchanged so the scale and performance of the fabric is manageable and predictable.

Mirroring current generation switches, hereafter called the lower-bandwidth baseline, forms a double-bandwidth step-up in performance without the drawbacks of other methods of increasing bandwidth. The cost of mirroring the switches is simply twice that of the lower-bandwidth baseline per link. The mirrored switch configuration adopts a form of SerDes lane count increase without change to the SerDes rate. This is enabled by a switching function in software or hardware that balances transmission over the parallel networks creating a fabric of mirrored switches and mirrored topologies according to embodiments of the present invention.

The inventive approach of mirroring switches has the advantage of reusing current generation switches having the lower-bandwidth baseline but doubling overall bandwidth for the fabric. Optimized packaging minimizes cable cost and complexity. Furthermore, this bandwidth increase through use of more SerDes lanes in parallel, without changing their data rate, also retains the full reach and raw bit error rate of the lower-bandwidth baseline. In contrast, shifting to higher-bandwidth SerDes necessarily compromises reach and/or raw bit error rate.

Turning now to FIG. 1, FIG. 1 depicts a high-performance computing environment according to example embodiments of the present invention. The example high-performance computing environment of FIG. 1 includes a fabric (140) which includes an aggregation of a service node (130), an Input/Output (“I/O”) node (110), a plurality of compute nodes (116) each including a host fabric adapter (‘HFA’) (114), and a topology (110) of switches (102) and links (103). The fabric (140) according to the example of FIG. 1 is a unified computing system that includes interconnected nodes and switches that often look like a weave or a fabric when seen collectively. In the example of FIG. 1, the fabric (140) includes compute nodes (116), host fabric adapters (114) and switches (102). The switches (102) of FIG. 1 are coupled for data communications to one another with links to form one or more topologies (110). A topology is the connectivity pattern among switches, HFAs, and the bandwidth of those connections. Switches, HFAs, and their links may be connected in many ways to form many topologies, each designed to optimize performance for their purpose. Examples of topologies useful according to embodiments of the present invention include HyperX topologies, Star topologies, Dragonflies, Megaflies, Trees, Fat Trees, and many others.

The example of FIG. 1 depicts a Dragonfly topology which is an all-to-all connected set of virtual router groups. Virtual router groups (‘VRGs’) (105) are themselves a collection of nodes and switches with their own topology-in this case also a Dragonfly. In the example of FIG. 1, the switches themselves are mirrored (160) according to embodiments of the present invention as will occur to those of skill in the art. ‘Mirror,’ ‘mirroring,’ or ‘mirrored’ in this disclosure is used to describe the parallel use of more than one switch with the same or very similar specifications. The mirrored switches are placed in corresponding locations within independent topologies which themselves are arranged as mirrored or dual topologies providing data transmission for the compute nodes of the fabric. In this way, the fabric comprises mirrored parallel and independent topologies available to the compute nodes of the fabric for data transmission.

The term mirror is not meant to limit the number of mirrored switches or mirrored topologies to two. In fact, embodiments of the present invention may include three or more mirrored switches in three or more mirrored topologies each connected to an adapter for a compute node such that the compute node may use all three or more topologies for data transmission to other nodes of the fabric. Mirroring the switches and their links and combining them in an adapter enables increasing the bandwidth of the fabric without many of the traditional drawbacks

The HPC (100) of FIG. 1 includes a service node (130). The service node (130) of FIG. 1 provides service common to pluralities of compute nodes, loading programs into the compute nodes, starting program execution on the compute nodes, retrieving results of program operations on the compute nodes, and so on. The service node of FIG. 1 runs a service application and communicates with administrators (128) through a service application interface that runs on computer terminal (122). The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a graphical user interface (‘GUI’) (126) allowing administrators (128) to configure and administer the fabric manager (124) through a terminal (122) and in so doing configure and administer the fabric (140). In some embodiments of the present invention, routing algorithms are controlled by the fabric manager (124) which in some cases configures routes from endpoint to endpoint.

The compute nodes (116) of FIG. 1 operate as individual computers including at least one central processing unit (‘CPU’), volatile working memory and non-volatile storage. The compute nodes are connected to the switches (102) and links (103) through a host interface adapter (114). The hardware architectures and specifications for the various compute nodes vary and all such architectures and specifications are well within the scope of the present invention as will occur to those of skill in the art. Such non-volatile storage may store one or more applications or programs for the compute node to execute.

Each compute node (116) in the example of FIG. 1 has installed upon it or is connected for data communications with a host fabric adapter (114) (‘HFA’). Host fabric adapters according to example embodiments of the present invention deliver high bandwidth and increase cluster scalability and message rate while reducing latency. The HFA adapts packets from the node for transmission through the fabric. The example HFA of FIG. 1 provides matching between the requirements of applications and fabric, maximizing scalability and performance. The HFA of FIG. 1 provides increased application performance including dispersive routing and congestion control.

The example HFA (114) of FIG. 1 connects a host such as a compute node (116) to the fabric (140) of mirrored switches (102) and links (103). The HFAs (114) of FIG. 1 includes an interconnect (360) adapted to receive, from corresponding ports of mirrored switches, one link from one port of one of the mirrored switches and one link from a corresponding port of another of the mirrored switches. Corresponding ports means ports on each switch with the same function in the topology. Such ports may or may not be in a corresponding physical location on the individual switches but the ports function topologically in the same manner with regard to their respective mirrored topology. Once so connected, compute nodes of the fabric are directly linked with two or more parallel and independent topologies for data transmission.

The switches (102) of FIG. 1 are multiport modules of automated computing machinery, hardware and firmware, that receive and transmit packets. Typical switches receive packets, inspect packet header information, and transmit the packets according to routing tables configured in the switch. Often switches are implemented as or with one or more application specific integrated circuits (‘ASICs’). In many cases, the hardware of the switch implements packet routing and firmware of the switch configures routing tables, performs management functions, fault recovery, and other complex control tasks as will occur to those of skill in the art.

The switches (102) of the fabric (140) of FIG. 1 are connected to other switches with links (103) to form one or more topologies. Links (103) may be implemented as copper cables, fiber optic cables, and others as will occur to those of skill in the art. A topology according to the example of FIG. 1 is the connectivity pattern among switches, HFAs, and the bandwidth of those connections. Switches, HFAs, and links may be connected in many ways to form and many topologies, each designed to perform in ways optimized for their purposes.

In some embodiments, the use of double density cables may also provide increased bandwidth in the fabric. Such double density cables may be implemented with optical cables, passive copper cables, active copper cables and others as will occur to those of skill in the art. An example cable useful with mirrored switch configurations according to embodiments of the present invention include QSFP-DD cables. QSFP-DD stands for Quad Small Form Factor Pluggable Double Density. The QSFP-DD complies with the IEEE802.3bs and QSFP-DD MSA standards.

The example of FIG. 1 includes an I/O node (110) responsible for input and output to and from the high-performance computing environment. The I/O node (110) of FIG. 1 is coupled for data communications to data storage (118) and a terminal (122) providing information, resources, GUI interaction and so on to an administrator (128).

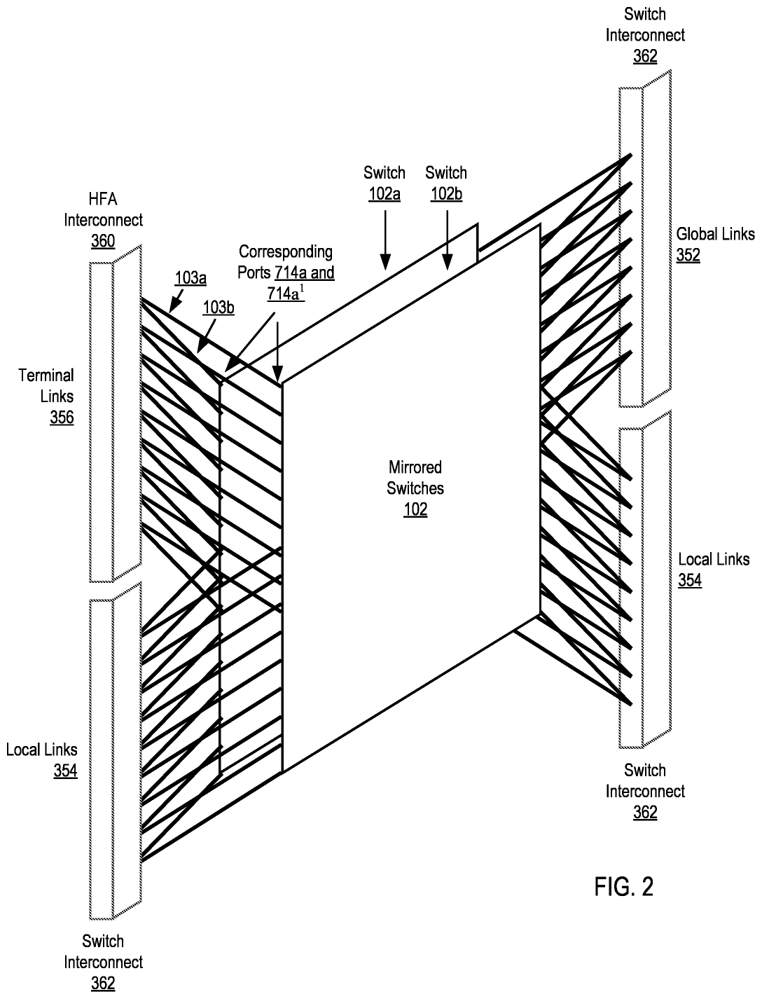

For further explanation, FIG. 2 sets forth a line drawing of mirrored switches according to example embodiments of the present invention. Such mirrored switches may be arranged to form mirrored parallel and independent topologies. In the example of FIG. 2, each switch (102s and 102b) has the same baseline bandwidth and the same radix and port configurations. The particular ratio of allocated ports in the example of FIG. 2 dictates that each switch provides ports for eight terminal links (356) to compute nodes through HFA interconnects (360) and sixteen ports in switch interconnects (362) for sixteen local links to other switches in the VRG and eight ports for global links (352) to other VRGs. The switches (102a and 102b) have corresponding ports (714a and 714b) accommodating the terminal links (356), the local links (354), and the global links (352).

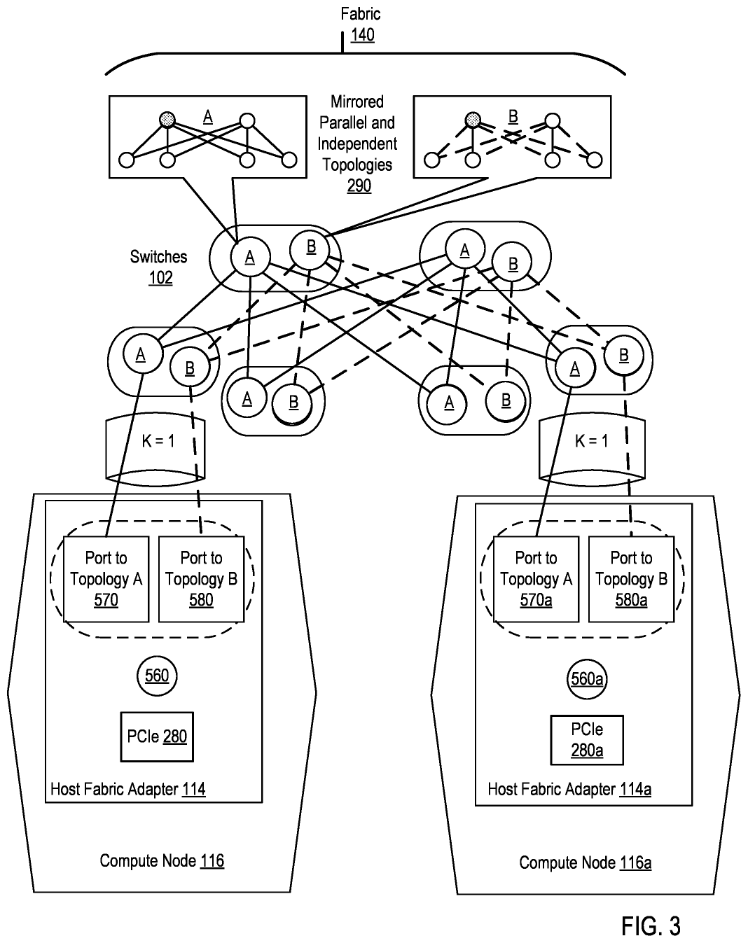

For further explanation, FIG. 3 sets forth a line drawing of a simplified example of a fabric having mirrored topologies of mirrored switch configurations according to example embodiments of the present invention. The example of FIG. 3 illustrates two compute nodes (116 and 116a) each connected to two sets of switches both of which are arranged in a two-tier tree topology (290). The two topologies (290) are mirrored in that the sets of switches comprising them have the same baseline bandwidths and corresponding radix and port configurations. The parallel topologies are independent and mirror one another. To illustrate this mirrored configuration, a single switch in each topology is highlighted to demonstrate that the switch resides in same location in its respective topology as the corresponding switch in the mirrored topology. Together, these topologies and their compute nodes create a simplified fabric.

In the example of FIG. 3, each compute node (116 and 116a) includes a host fabric adapter (114) with a PCIe module (280), steering logic (560), and a dedicated port (570 and 570a) to topology A and a dedicated port (580 and 580a) to topology B. To clearly illustrate the parallel and independent nature of the two topologies, the links between the switches of topology A are illustrated with straight lines and the links between the switches of topology B are illustrated with dashed lines. PCIe is PCI Express (Peripheral Component Interconnect Express), abbreviated as PCIe or PCI-e, is a high-speed serial computer expansion bus standard. The description of PCIe is for explanation and not for limitation. In alternative embodiments, for example, a Compute Express Link (‘CXL’) may be used instead of PCIe. CXL is an open standard for high-speed central processing unit (CPU)-to-device and CPU-to-memory connections, designed for high performance data center computers. CXL is built on the PCI Express (PCIe) physical and electrical interface and includes PCIe-based block input/output protocol (CXL.io) and new cache-coherent protocols for accessing system memory (CXL.cache) and device memory (CXL.mem).

The steering logic (560 and 560a) provides logic for routing packets through ports dedicated to one of the mirrored switches or the other. The mirrored switches reside in the same location in each of the mirrored topologies providing parallel and independent data transmission between the compute nodes. Such steering logic may route packets among the dedicated ports and the parallel and independent topologies according to packet header information identifying a particular topology, switch, link or other information for selecting the port and topology for routing the packet.

From a topological perspective, the switches of the mirrored switches and their links to the HFA (114) operate in many ways as a single switch with twice the bandwidth and twice the radix. The abbreviation K is the identification of the number of links. In the example of FIG. 1, the two links between the mirrored switches and the compute node may be considered topologically as a single link. As such, for configuration and other purposes, the two links are designated as a single link or K=1.

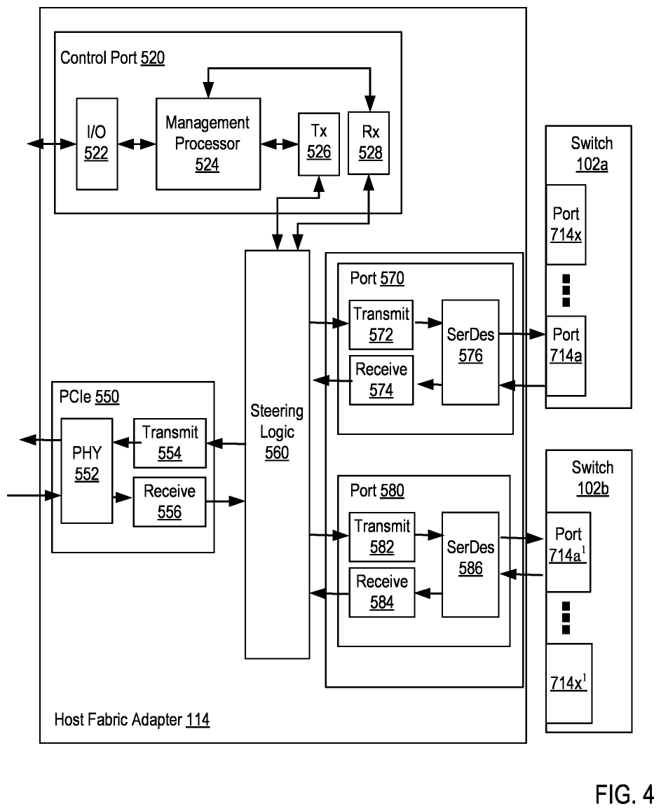

For further explanation, FIG. 4 sets forth a block diagram of an example host fabric adapter according to embodiments of the present invention. The host fabric adapter (114) of FIG. 4 includes a control port (520) with an I/O adapter (522) for communications with the control port and a management processor (524) and a receive controller (528) and a transmit controller (526). The management processor (524) is responsible for configuration and status information controlling the administration of packets by the HFA.

The HFA (114) of FIG. 4 includes a PCIe module (550) having a physical interconnect (522) with the compute node the HFA services and a transmit controller (554) and receive controller (556). The HFA also includes two dedicated ports (570 and 580) adapted to receive from corresponding ports (714a and 714a1) of the at least two switches (102a and 102b), one link from one port (714a) of one of the switches (102a) and one link from a corresponding port (714a1) of another of the switches (102b). The dedicated ports (570 and 580) each include a transmit controller (572 and 582), a receive controller (574 and 584) and a Serializer/Deserializer (SerDes).

The HFA (114) of FIG. 4 includes steering logic (560) for routing packets through ports (570 and 580) dedicated to one of the mirrored switches (102a) or the other (102b). The mirrored switches reside in the same location in each of the mirrored topologies providing parallel and independent data transmission between the compute nodes. Such steering logic may route packets among the dedicated ports and the parallel and independent topologies according to packet header information identifying a particular topology, switch, link or other information for selecting the port and topology for routing the packet.

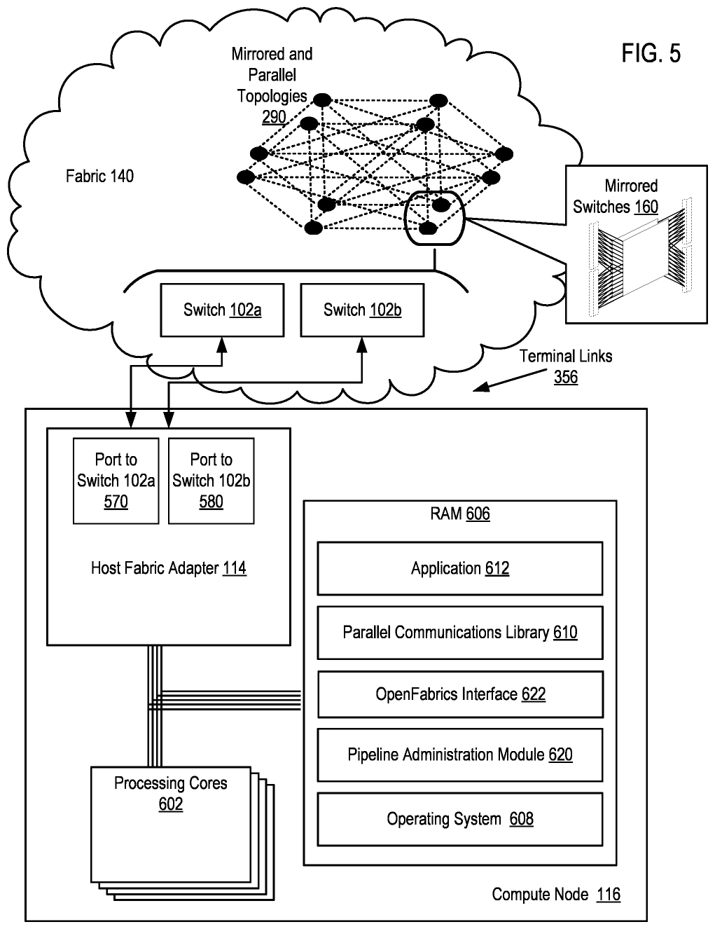

In the example of FIG. 4, the HFA (114) includes steering logic (560) to route packets through one dedicated port or another to the parallel and independent topologies. In some embodiments of the present invention, the HFA may not include such steering logic and that steering is administered in software by the compute node. For further explanation, therefore, FIG. 5 sets forth a block diagram of a compute node configured for a fabric of mirrored switches according to embodiments of the present invention. The compute node (116) of FIG. 5 includes processing cores (602), random access memory (‘RAM’) (606) and a host fabric adapter (114). The example compute node (116) is coupled for data communications with a fabric (140) that includes mirrored parallel and independent topologies comprised of mirrored switches (160) according to the present invention. The mirrored switches (160) have corresponding baseline bandwidths and corresponding radix, and port configurations and are arranged in corresponding locations in the parallel and independent topologies. Each topology exposes its complete bandwidth to the compute nodes attached to it. As such, two topologies double the exposed bandwidth, three triples the exposed bandwidth and so on.

Stored in RAM (606) in the example of FIG. 5 is an application (612), a parallel communications library (610), an OpenFabrics Interface module (622), a pipeline administration module (620), and an operating system (608). Applications for high-performance computing environments are often directed to complex problems of science, engineering, business, and others.

A parallel communications library (610) is a library specification for communication between various nodes and clusters of a high-performance computing environment. A common protocol for HPC computing is the Message Passing Interface (‘MPI’). MPI provides portability, scalability, and high-performance. MPI may be deployed on many distributed architectures, whether large or small, and each operation is often optimized for the specific hardware on which it runs.

OpenFabrics Interfaces (OFI), developed under the OpenFabrics Alliance, is a collection of libraries and applications used to export fabric services. The goal of OFI is to define interfaces that enable a tight semantic map between applications and underlying fabric services. The OFI module (622) of FIG. 5 packetizes the message stream from the parallel communications library for transmission.

The compute node of FIG. 5 also includes pipeline administration module (620). The pipeline administration module is a module of automated computing machinery configured to adapt packets for transmission and reception through the individual parallel and independent topologies (290) of the fabric. The pipeline administration module (620) of FIG. 5 is configured to identify to the host fabric adapter which dedicated port (570 and 580) to use for data transmission. Port (570) is adapted to receive a link from switch (102a) which is located in the same location in one of the parallel topologies as switch (102b) in the other parallel topology. Port (580) is adapted to receive a link from switch (102b) for transmission through the parallel topology in which switch (102b) resides.

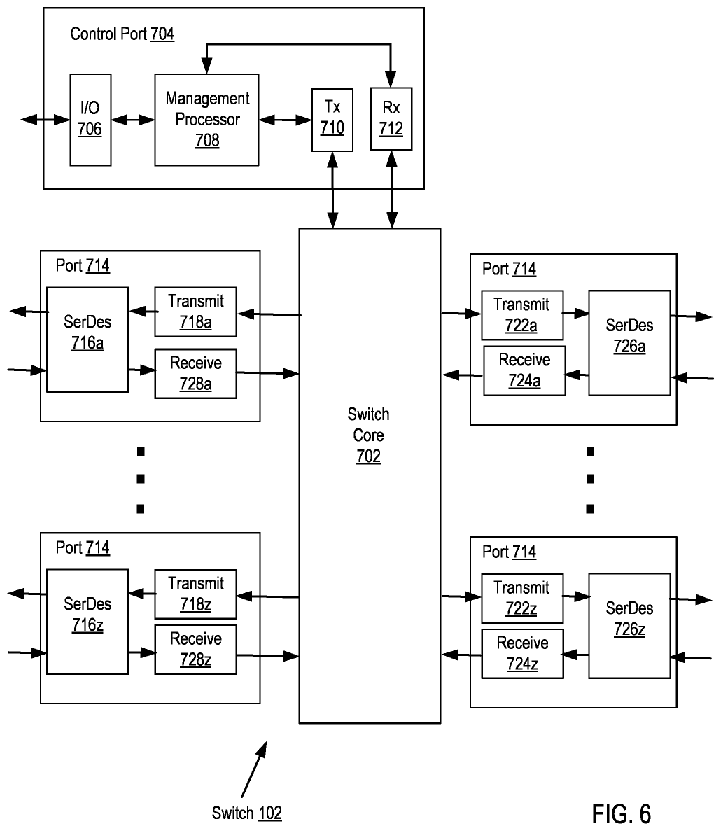

For further explanation, FIG. 6 sets forth a block diagram of an example switch. The example switch (102) of FIG. 6 includes a control port (704), a switch core (702), and a number of ports (714a-714z) and (720a-720z). The control port (704) of FIG. 10 includes an input/output (′I/O′) module, a management processor (708), and a transmission (710) and reception (712) controllers. The management processor (708) of the example switch of FIG. 6 maintains and updates routing tables for the switch to use in adaptive routing according to embodiments of the present invention. In the example of FIG. 10, each receive controller maintains the latest updated routing tables.

The example switch (102) of FIG. 6 includes a number of ports (714a-714z and 720a-720z). The designation of reference numeral 714 and 720 with the alphabetical appendix of a-z is to explain that there may be many ports connected to a switch. Switches useful in static dispersive routing according to embodiments of the present invention may have any number of ports-more or less than 26 for example. Each port (714a-714z and 720a-720z) is coupled with the switch core (702) and has a transmit controller (718a-718z and 722a-722) and a receive controller (728a-728 and 724a-724z) and a SerDes (716a-716z and 726a-726z).

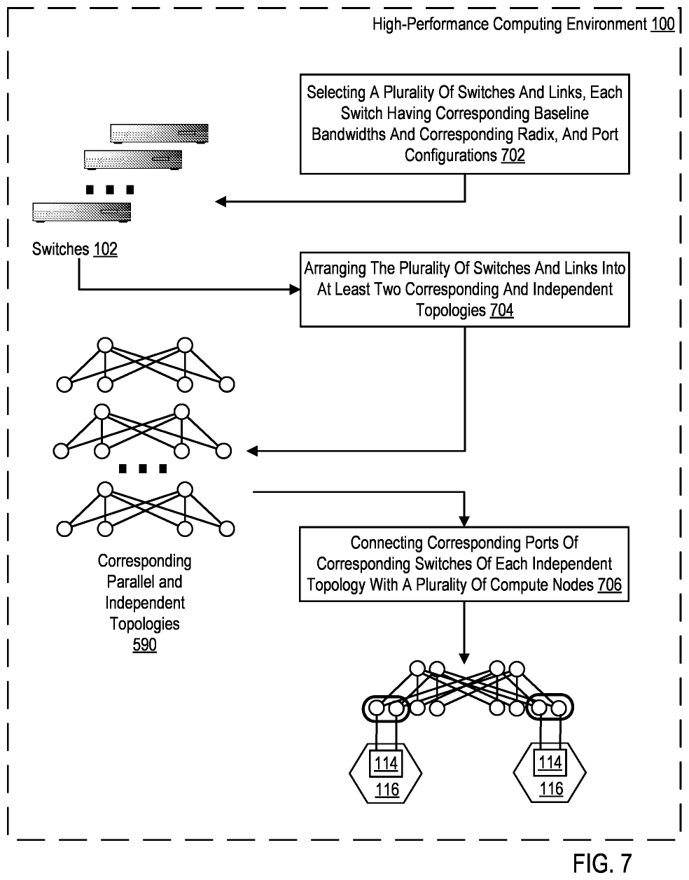

For further explanation, FIG. 7 sets forth a flowchart illustrating an example method of configuring a fabric for a high-performance computing environment. As discussed above, mirroring the switches used in a current generation, hereafter called the lower-bandwidth baseline, forms a double-bandwidth step-up in performance without the drawbacks of other methods of increasing bandwidth.

The method of FIG. 7 includes selecting (702) a plurality of switches (102) and links (103), each switch having corresponding baseline bandwidths and corresponding radix, and port configurations. In some embodiments, selecting a plurality of switches and links includes selecting a plurality of switches having the same specifications, such as switches of the same make and model for mirroring according to embodiments of the present invention. The method of FIG. 7 may also include selecting double density optical cables for use in forming mirrored topologies.

The method of FIG. 7 includes arranging the plurality of switches and links into at least two corresponding parallel and independent topologies. In many embodiments, the switches and links are arranged to form copies of the same topology. Example topologies useful in mirrored switch configurations according to according to embodiments of the present invention include HyperX topologies, Star topologies, Dragonflies, Megaflies, Trees, Fat Trees, and many others as will occur to those of skill in the art.

The method of FIG. 7 includes connecting corresponding ports of corresponding switches of each independent topology with a plurality of compute nodes, wherein each compute node has a host fabric adapter with a dedicated port adapted to independently transmit and receive data to a particular topology. As mentioned above, corresponding ports means ports on each switch with the same function in the topology. Such ports may or may not be in a corresponding physical location on the individual switches but the ports function topologically in the same manner with regard to their respective mirrored topology. Once so connected, compute nodes of the fabric are directly linked with two or more parallel and independent topologies for data transmission.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A mirrored switch configuration, the switch configuration comprising:
at least two switches, each having corresponding baseline bandwidths and corresponding radix and port configurations;
a plurality of links, and
a host fabric interface adapter (‘HFA’) including an interconnect adapted to receive, from corresponding ports of the at least two switches, one link from one port of one of the at least two switches and one link from a corresponding port of another of the at least two switches.

2. The mirrored switch configuration of claim 1 wherein the one link from one port of one of the at least two switches and the one link from a corresponding port of another of the at least two switches is implemented through a double density cable adapted for the host HFI and the at least two switches.

3. The mirrored switch configuration of claim 1 wherein the HFA is coupled with a compute node and wherein the compute node comprises a processor and memory and a pipeline administration module stored in memory configured to administer packet traffic through the HFA to the at least two switches.

4. The mirrored switch configuration of claim 3 wherein the pipeline administration module is further configured to selectively administer packet traffic among the at least two switches.

5. The mirrored switch configuration of claim 3 wherein the pipeline administration module is further configured to load balance packet traffic among the at least two switches.

6. The mirrored switch configuration of claim 1 wherein the HFA includes steering logic configured to selectively route packets among the ports to the switches.

7. The mirrored switch configuration of claim 1 wherein the HFA includes steering logic configured to load balance packet traffic among the ports to the switches.

8. The mirrored switch configuration of claim 1 wherein the mirrored switch configuration retains the reach and raw bit error rate of the baseline links.

9. The mirrored switch configuration of claim 1 wherein the at least two switches comprise three or more switches.

10. A host fabric adapter comprising:
a high-speed serial computer expansion bus;
at least two dedicated ports configured to receive links from corresponding ports of at least two switches; each of the at least two switches comprising corresponding switches in parallel and independent topologies.

11. The host fabric adapter of claim 10 further comprising steering logic configured to selectively transmit packets among the at least two ports.

12. The host fabric adapter of claim 10, wherein the high-speed serial computer expansion bus is a Peripheral Component Interconnect Express bus coupled for data communications with a compute node.

13. The host fabric adapter of claim 10, wherein the high-speed serial computer expansion bus is a Compute Express Link bus coupled for data communications with a compute node.

14. The host fabric adapter of claim 10 wherein the host fabric adapter, the compute node, the switches, and the links are components of a fabric of a high-performance computing environment.

15. A high-performance computing environment comprising:
a fabric comprising a plurality of switches and links configured into at least two parallel and independent topologies, the switches each having corresponding baseline bandwidths and corresponding radix and port configurations;
a plurality of compute nodes each including a host fabric adapter adapted for data transfer through ports dedicated to each of the topologies.

16. The high-performance computing environment of claim 15 wherein the host fabric adapter includes a high-speed serial computer expansion bus and at least two ports configured to receive links from corresponding ports of at least two switches.

17. The high-performance computing environment of claim 16 further comprising steering logic configured to selectively transmit packets among the at least two ports.

18. The high-performance computing environment of claim 16 further comprising steering logic configured to load balance packet traffic among the at least two ports.

19. The high-performance computing environment of claim 15, wherein the high-speed serial computer expansion bus is a Peripheral Component Interconnect Express bus coupled for data communications with a compute node.

20. The high-performance computing environment of claim 15, wherein the high-speed serial computer expansion bus is a Compute Express Link bus coupled for data communications with a compute node.

21. The high-performance computing environment of claim 15 wherein the compute node comprises a processor and memory and a pipeline administration module stored in memory configured to administer packet traffic through the host fabric adapter to the at least two parallel and independent topologies.

22. The high-performance computing environment of claim 21 wherein the pipeline administration module is further configured to administer packet traffic among the at least two parallel and independent topologies.

23. The high-performance computing environment of claim 21 wherein the pipeline administration module is further configured to load balance packet traffic among the at least two parallel and independent topologies.

24. A method of configuring a fabric for a high-performance computing environment, the method comprising:
selecting a plurality of switches and links, each switch having corresponding baseline bandwidths and corresponding radix, and port configurations;
arranging the plurality of switches and links into at least two corresponding parallel and independent topologies;
connecting corresponding ports of corresponding switches of each independent topology with a plurality of compute nodes, wherein each compute node has a host fabric adapter with a dedicated port adapted to independently transmit and receive data to a particular topology.

25. The method of claim 24 wherein the links comprise double-density cables.

26. The method of claim 24 wherein the host fabric adapter comprises a dedicated port adapted to independently transmit and receive data to each parallel and independent topology.

27. The method of claim 24 wherein the host fabric adapter further comprises steering logic configured to selectively transmit packets among the dedicated ports.

28. The method of claim 24 wherein the host fabric adapter further comprises steering logic configured to load balance packet traffic among the dedicated ports.
